(19) United States
(12) Patent Application Publication
(10) Pub. No.: US 2008/0059447 A1
(43) Pub. Date: Mar. 6, 2008

(54) SYSTEM, METHOD AND COMPUTER PROGRAM PRODUCT FOR RANKING PROFILES

(75) Inventors: Jeffrey B. Winner, Los Altos Hills, CA (US); Hongche Liu, Fremont, CA (US); Jaideep Singh, San Carlos, CA (US); Jatinder Bhatti, Redwood City, CA (US)

Correspondence Address: Zilka-Kotab, PC, P.O. BOX 721120, SAN JOSE, CA, 95172-1120, US

(73) Assignee: SPOCK NETWORKS, INC.

(21) Appl. No.: 11/466,944

(22) Filed: Aug. 24, 2006

(51) Int. Cl. G06F 17/30

(52) U.S. Cl. 707/5

(57) ABSTRACT

A system, method and computer program product are provided. In use, feedback relating to tags associated with a plurality of profiles is received. In addition, a search query is received. Further, a subset of the profiles is identified based on the search query. The subset of the profiles is also ranked based on the feedback. Moreover, the subset of the profiles is displayed based on the ranking.

### BACKGROUND AND FIELD OF THE INVENTION

The present invention relates to profiling various entities, and more particularly to ranking profiles.

### SUMMARY

A system, method and computer program product are provided. In use, feedback relating to tags associated with a plurality of profiles is received. In addition, a search query is received. Further, a subset of the profiles is identified based on the search query. The subset of the profiles is also ranked based on the feedback. Moreover, the subset of the profiles may be displayed based on the ranking.

### BRIEF DESCRIPTION OF THE DRAWINGS

FIG. 1 illustrates a network architecture, in accordance with one embodiment.

FIG. 2 illustrates an exemplary computer system, in accordance with one embodiment.

FIG. 3 illustrates a method for ranking profiles based on feedback, in accordance with one embodiment.

FIG. 4 illustrates a system for ranking profiles based on feedback, in accordance with another embodiment.

FIG. 5 illustrates a method for applying a tag to a profile, in accordance with yet another embodiment.

FIG. 6 illustrates a method for voting with respect to a tag, in accordance with still yet another embodiment.

FIG. 7 illustrates a method for performing a search based on a tag, in accordance with another embodiment.

FIG. 8 illustrates a graphical user interface (GUI) for voting with respect to a tag associated with a profile, in accordance with one embodiment.

FIGS. 9A-B illustrate GUIs for soliciting votes with respect to tags associated with a profile, in accordance with another embodiment.

FIGS. 10A-B illustrate GUIs for searching profiles utilizing tags and for displaying search results based on a ranking associated with the tags, in accordance with yet another embodiment.

FIG. 11 illustrates a GUI for voting with respect to a tag associated with a profile within displayed search results, in accordance with still yet another embodiment.

### DETAILED DESCRIPTION

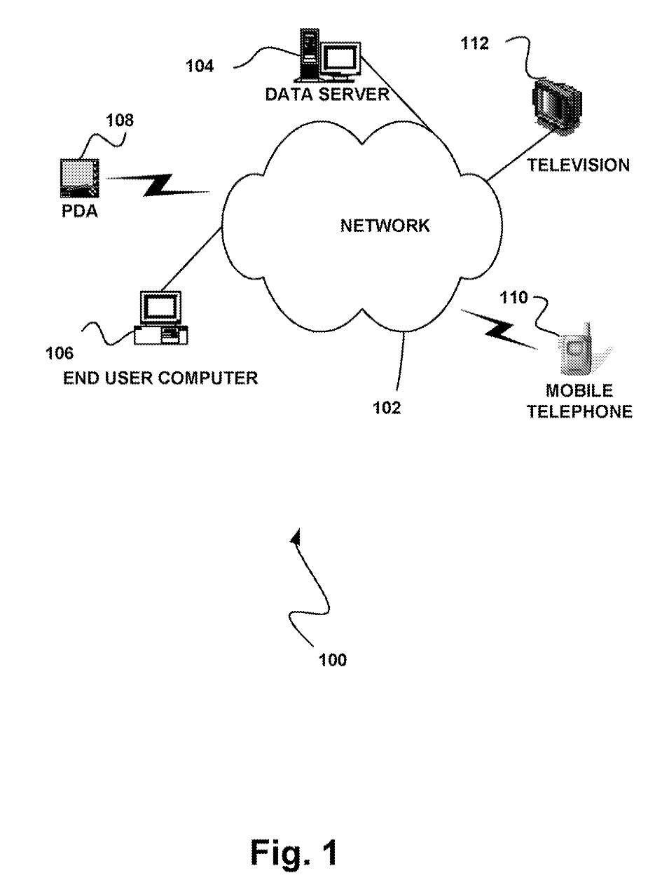

FIG. 1 illustrates a network architecture 100, in accordance with one embodiment. As shown, a network 102 is provided. In the context of the present network, architecture 100, the network 102 may take any form including, but not limited to a telecommunications network, a local area network (LAN), a wireless network, a wide area network (WAN) such as the Internet, etc. While only one network is shown, it should be understood that two or more similar or different networks 102 may be provided.

Coupled to the network 102 is a plurality of devices. For example, a server computer 104 and an end user computer 106 may be coupled to the network 102 for communication purposes. Such end user computer 106 may include a desktop computer, lap-top computer, and/or any other type of logic. Still yet, various other devices may be coupled to the network 102 including a personal digital assistant (PDA) device 108, a mobile phone device 110, a television 112, etc.

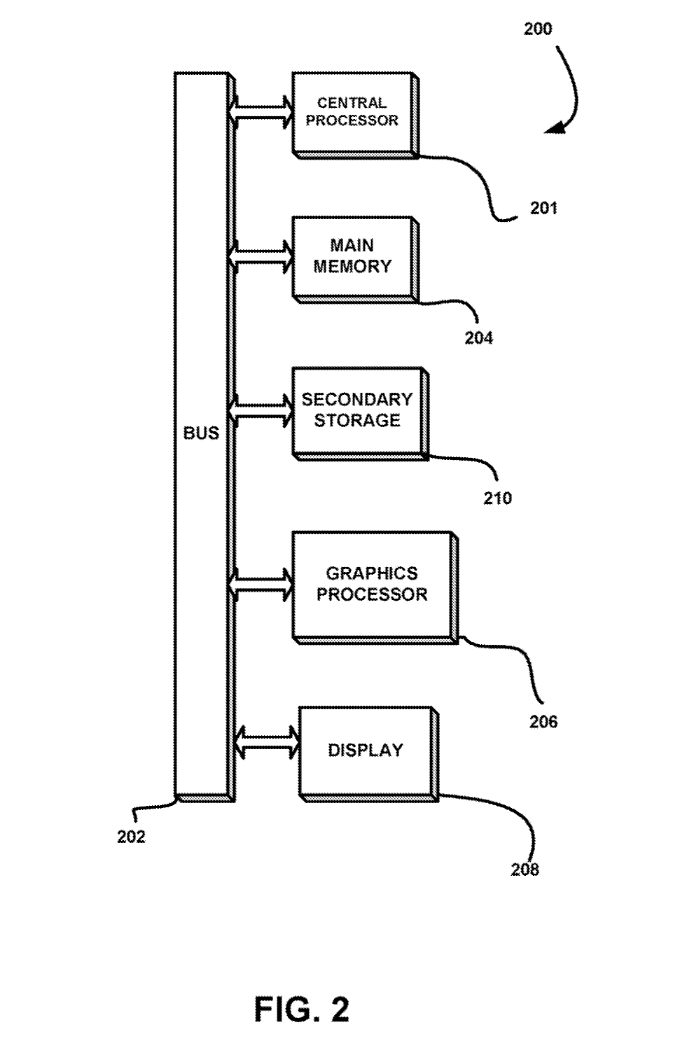

FIG. 2 illustrates an exemplary computer system 200, in accordance with one embodiment. As an option, the computer system 200 may be implemented in the context of any of the devices of the network architecture 100 of FIG. 1. Of course, the computer system 200 may be implemented in any desired environment.

As shown, a computer system 200 is provided including at least one central processor 201 which is connected to a communication bus 202. The computer system 200 also includes main memory 204 [e.g. random access memory (RAM), etc.]. The computer system 200 also includes a graphics processor 206 and a display 208.

The computer system 200 may also include a secondary storage 210. The secondary storage 210 includes, for example, a hard disk and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 204 and/or the secondary storage 210. Such computer programs, when executed, enable the computer system 200 to perform various functions. Memory 204, storage 210 and/or any other storage are possible examples of computer-readable media.

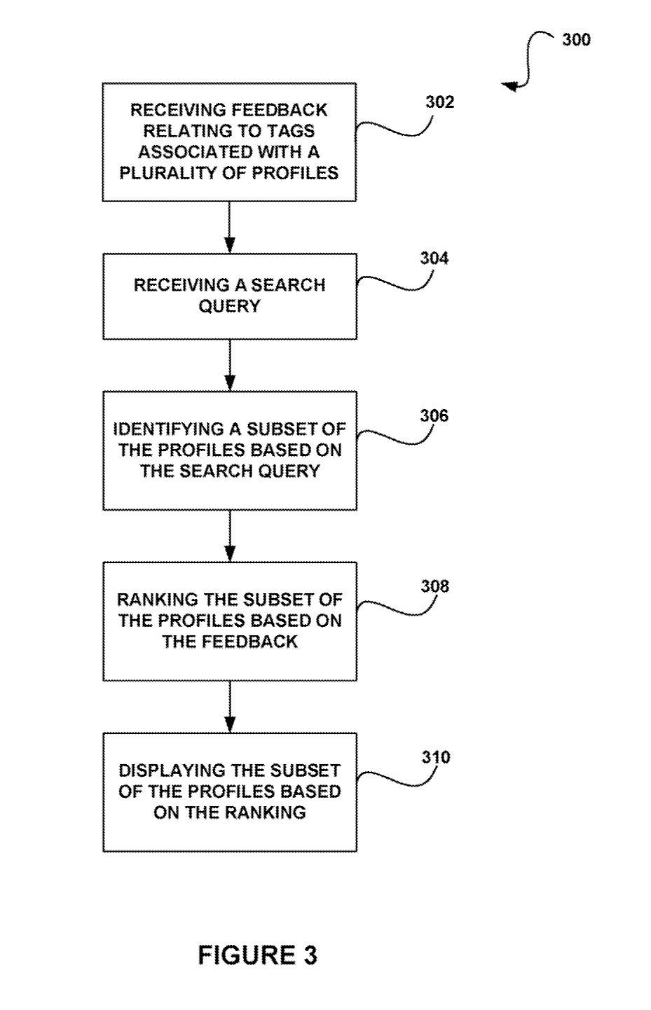

FIG. 3 illustrates a method 300 for ranking profiles based on feedback, in accordance with one embodiment. As an option, the present system 300 may be implemented in the context of the architecture and environment of FIGS. 1 and/or 2. Of course, however, the system 300 may be implemented in any desired environment.

As shown in operation 302, feedback relating to tags associated with a plurality of profiles is received. The profiles may include any information that describes an entity. For example, in various embodiments, the entity may include a person, a place, a thing, etc. Thus, the profiles may describe people, organizations (e.g. companies, etc.), restaurants, stores, products, digital media (e.g. video, audio, image, etc.), and/or any other entity, for that matter. In addition, each profile may be associated with a particular entity, such that the particular entity may manage its associated profile.

Further, in the context of the present description, the tags may each include any data (e.g. word, phrase, text, etc.) capable of being associated with an entity. In one optional embodiment, the tags may describe one or more characteristics of the entity. For example, such characteristics may include physical characteristics, personality characteristics, product characteristics, company characteristics, and/or any other characteristics capable of being associated with the entity. In another embodiment, the tags may include data located within at least one of the profiles.

In yet another embodiment, the tags may be manually generated by a user associated with a corresponding one of the profiles. For example, the user may be associated with the entity to which the profile describes (e.g. may be the entity itself, may be an employee of the entity, may be a marketer of the entity, may manage the entity, etc.). As a further option, the tags may be manually generated by the user utilizing a graphical user interface (GUI). Moreover, the tags may be optionally generated utilizing a drag and drop operation, by manually entering the tag, etc.

In still yet another embodiment, the tags may be manually generated by a person other than the aforementioned user. As an option, such person may generate the tags only upon solicitation and/or confirmation by the user. Thus, the generation of tags associated with a profile may be managed by the user associated with the profile. In additional embodiments, the person (other than the user) may also be required to be associated with a profile, log-in prior to generating a tag, etc.

In still other embodiments, the tags may be automatically generated by a machine, may be imported (e.g. from an external source, etc.), may be generated through an analysis, etc. Of course, it should be united that the tags may be generated utilizing any desired combination of the above described techniques and/or may be generated utilizing any other technique resulting in the generation of a tag.

Also in the context of the present description, the feedback may include any input made in relation to the tags. In one optional embodiment, the feedback may be manually received from the aforementioned user of the profile or other persons. In other optional embodiments, the feedback may be automatically received from a machine, an internal source, an external source, and/or any other source capable of providing feedback. Moreover, the feedback may also be based on an analysis.

In one particular embodiment, the feedback may optionally include votes relating to the tags. Just by way of example, users or other persons may be capable of voting on the tags. In use, such votes may involve selecting a true option or a false option associated with a tag. Thus, the votes may reflect an agreement (e.g. a positive vote, etc.) or disagreement (e.g. a negative vote, etc.) with respect to the particular tag. In another embodiment, the votes may include selecting an amount of agreement and/or disagreement with a particular tag (e.g. based on a scale of 1-10, a percentage, etc.).

Of course, however, the feedback may include any numerical value, string, enumerated value and/or any other type of input provided in association with a tag. Still yet, the feedback may optionally be weighted. For example, the feedback may be weighted based on time (e.g. how recently the feedback was received, etc.) and/or distance (e.g. a geographic distance between the provider of the feedback and the profiled entity associated with the tag, or social distance, namely the degree of separation in a social network, etc).

As another example, the feedback may be weighted based on an authority of the entity providing the feedback. Such authority may be based on an amount of positive and/or negative feedback associated with the entity providing the feedback, a number of tags associated with the entity providing the feedback, a type of tags associated with the entity providing the feedback, and/or any other characteristics of the entity providing the feedback.

While operation 302 may or may not continuously occur at any time during execution of the following operations, a search query may be received at any given time, per operation 304. The search query may include any query that is capable of being used for searching any aspect of the profiles (e.g. tags associated with such profiles, etc.) that results in the identification of a subset of profiles, as will be set forth hereinafter in greater detail. In one embodiment, the search query may be used to search profiles within a database.

Further, in various embodiments, the search query optionally define parameters on which a search is to be based. For example, the search query may define tags, such that profiles associated with the defined tags are identified tags are identified by the search query. Also, the search query may or may not utilize Boolean logic (or any other type of logic) of defining such parameters.

Still yet, the search query may be received from a user. For example, the search query may be received from a user utilizing a GUI. Of course, however, the search query may be received from any entity and in any desired manner.

A subset of the profiles is then identified based on the search query, as shown in operation 306. In one embodiment, the subset of the profiles may be identified by comparing the search query with the tags and possible other data associated with the plurality of profiles. Thus, the subset of profiles may include only profiles with an associated tag that matches the search query. Of course, however, the subset of profiles may be identified in any desired manner based on the search query.

As shown in operation 308, the subset of the profiles is ranked based on the feedback. In one embodiment, the profiles may be ranked based on the feedback associated with a tag that matches the search query. For example, profiles with the greatest number of positive votes for the particular tag matching the search query may be ranked first, and so on. In this way, the profiles may be ranked solely based on a number of instances of positive votes associated with a particular tag.

In another embodiment, the profiles may be ranked based on a ratio of positive votes to negative votes with respect to the particular tag that matches the search query, where profiles with the greatest ratio of such positive votes to negative votes are ranked the highest, and so on. In this way, the profiles may be ranked based on a total number of instances of feedback associated with a particular tag. Of course, it should be noted, however, that the subset of the profiles may be ranked in any desired manner that is based on the feedback. In various embodiments, the subset of the profiles may also be ranked based on a strength of match between the query and the tags and possible other data associated with the profiles.

Moreover, the subset of the profiles is displayed based on the ranking, as shown in operation 310. The subset of the profiles may be displayed utilizing a GUI. Just by way of example, the subset of the profiles may be displayed utilizing a display of any of the devices described above with respect to FIGS. 1 and/or 2. As an option, the subset of the profiles may be displayed in a list in an order based on the ranking. Thus, profiles with the greatest ranking may be listed first. In this way, the aforementioned feedback may be utilized to rank such profiles.

More illustrative information will now be set forth regarding various optional architectures and features of different embodiments with which the foregoing framework may or may not be implemented, per the desires of the user. It should be strongly noted that the following information is set forth for illustrative purposes and should not be construced as limiting in any manner. Any of the following features may be optionally incorporated with or without the exclusion of other features described.

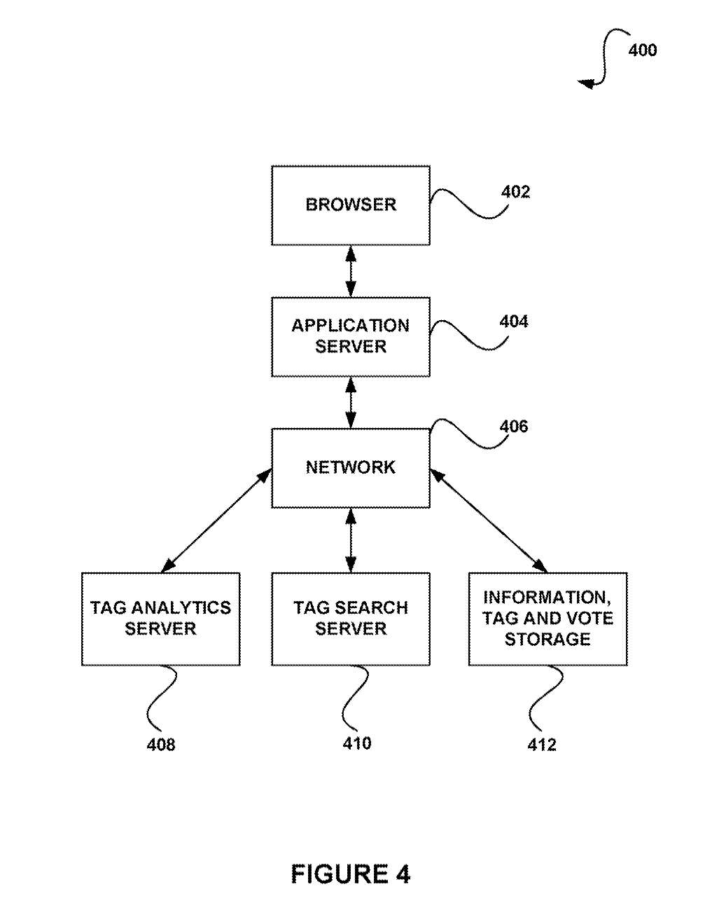

FIG. 4 illustrates a system 400 for ranking profiles based on feedback, in accordance with another embodiment. As an option, the system 400 may be implemented in the context of the details of FIGS. 1-3. Of course, however, the system 400 may be implemented in any desired environment. Further, the aforementioned definitions may equally apply to the description below.

As shown, a browser 402 is included which remains in communication with an application server 404. The browser 402 may include, for example, a hypertext transfer protocol capable browser. In addition, the browser 402 may connect to a network 406 (e.g. the Internet, etc.) via the application server 404.

The browser 402 may receive information form a user (or any other person, for that matter). In one embodiment, the browser 402 may receive tags from the user, where such tags are to be applied to a profile. In another embodiment, the browser 402 may receive search queries from the user (or any other person, for that matter), where such search queries return results of profiles that make the search query parameters.

In yet another embodiment, the browser 402 may receive votes from people with respect to tags associated with profiles. The browser 402 may then transmit such feedback to the application server 404. Moreover, the browser 402 may display information. For example, the browser 402 may display the profiles, tags, feedback, etc.

The application server 404 may connect to the network 406 through firewalls and/or load balancers. Moreover, the application server 404 may be implemented utilizing Apache, Hypertext Preprocessor (PHP), Ruby, Java Server Pages (JSP), and/or any other technology. In use., the application server 404 may receive information from the browser 402 and may, in turn, transmit such information to a tag analysis server 408, a tag search server 410, and/or an information, tag and/or vote storage 412 via the network 406.

The tag analytics server 408 may optionally include a software based server that performs statistical analysis of tags and the feedback on such tags. The tag analytics server 408 may also include a computer system, such as for example, any of the computer systems and components thereof described above with respect to FIGS. 1 and/or 2. In use, such computer system may store server software applications that are executable by a CPU and may also store data utilized by such server software applications.

The tag search server 410 may also include a computer system that executes server software applications. Furthermore, the tag search server 410 may itself include a computer system, such as for example, any of the computer systems and components thereof described above with respect to FIGS. 1 and/or 2. In this way, the tag search server 410 may search the information, tag and vote storage 412.

In particular, the tag search server 410 may search such information, tag and vote storage 412 for profiles associated with a search query received by the browser 402. Accordingly, the information, tag and voter storage 412 may include any computer storage device that stores information associated with profiles. For example, the information, tag and vote storage 412 may store tags associated with profiles along with feedback (e.g. votes, etc.) associated with such tags.

Based on the search, the tag search server 410 may output data to the browser 402. Of course, however, the tag and search server 410 may also output data to an external source (not shown). Thus, a system 400 is provided that is capable of receiving information via a browser 402 and processing such information. While the various components of the system 400 of FIG. 4 are shown to be separate and distinct, it should be noted that they may be integrated and/or relocated, as desired.

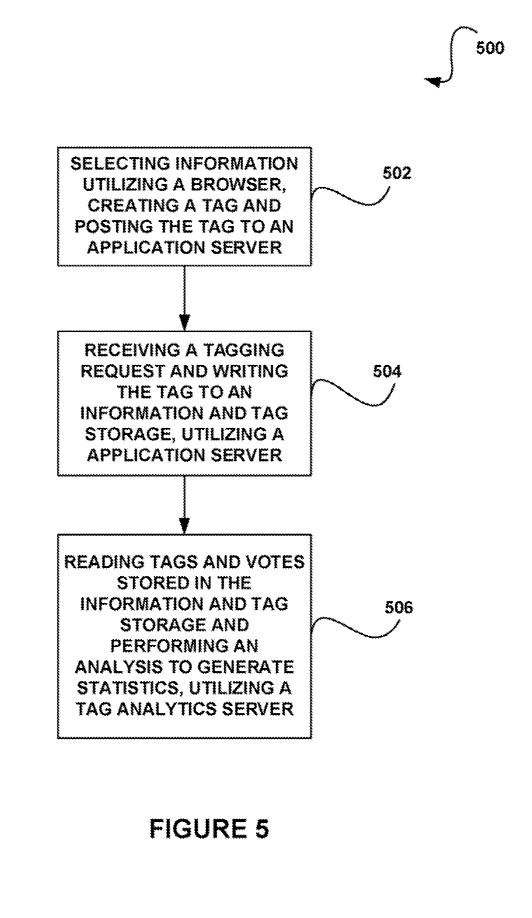

FIG. 5 illustrates a method 500 for applying a tag to a profile, in accordance with yet another embodiment. As an option, the method 500 may be implemented in the context of the details of FIGS. 1-4. Of course, however, the method 500 may be carried out in any desired environment. Frther, the aforementioned definitions may equally apply to the description below.

As shown in operation 502, information is selected utilizing a browser, a tag is created, and the tag is posted to an application server. The information may include, for example, a profile. Thus, a particular profile may be selected utilizing a browser. Such browser may include, for example, the browser described above with respect to FIG. 4.

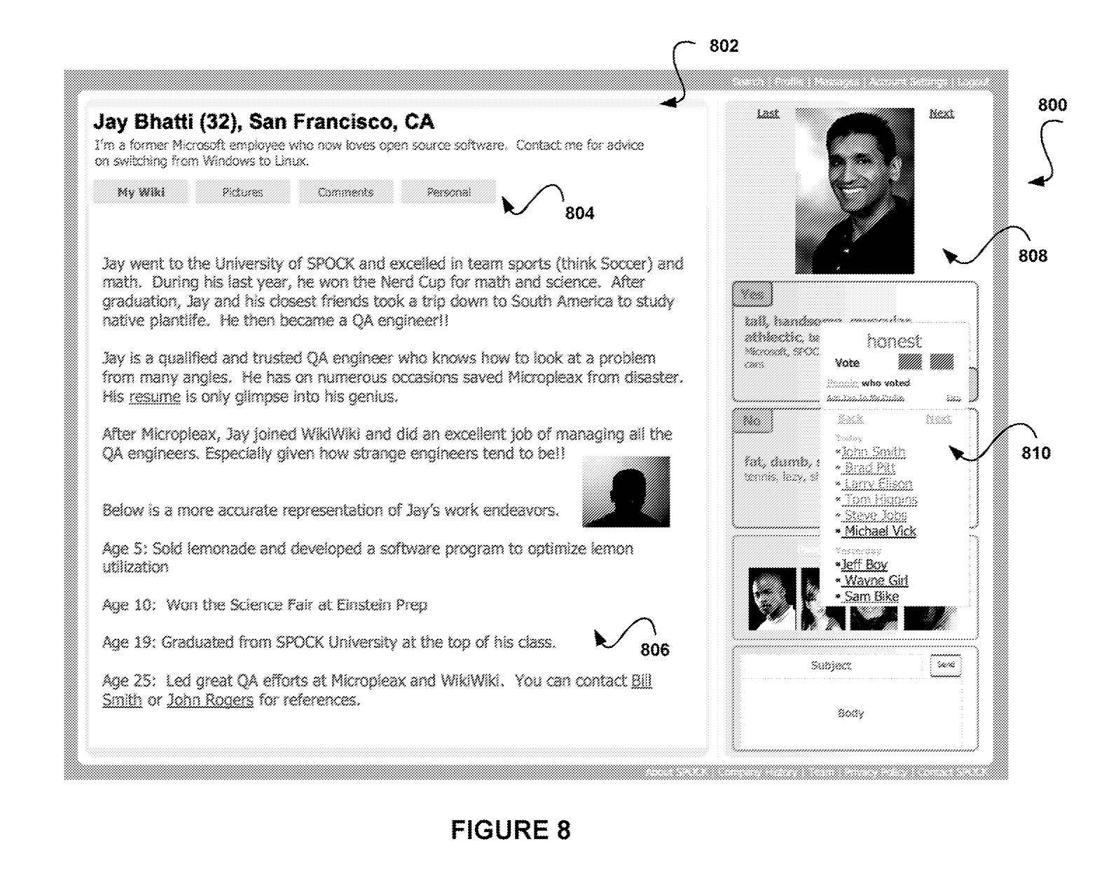

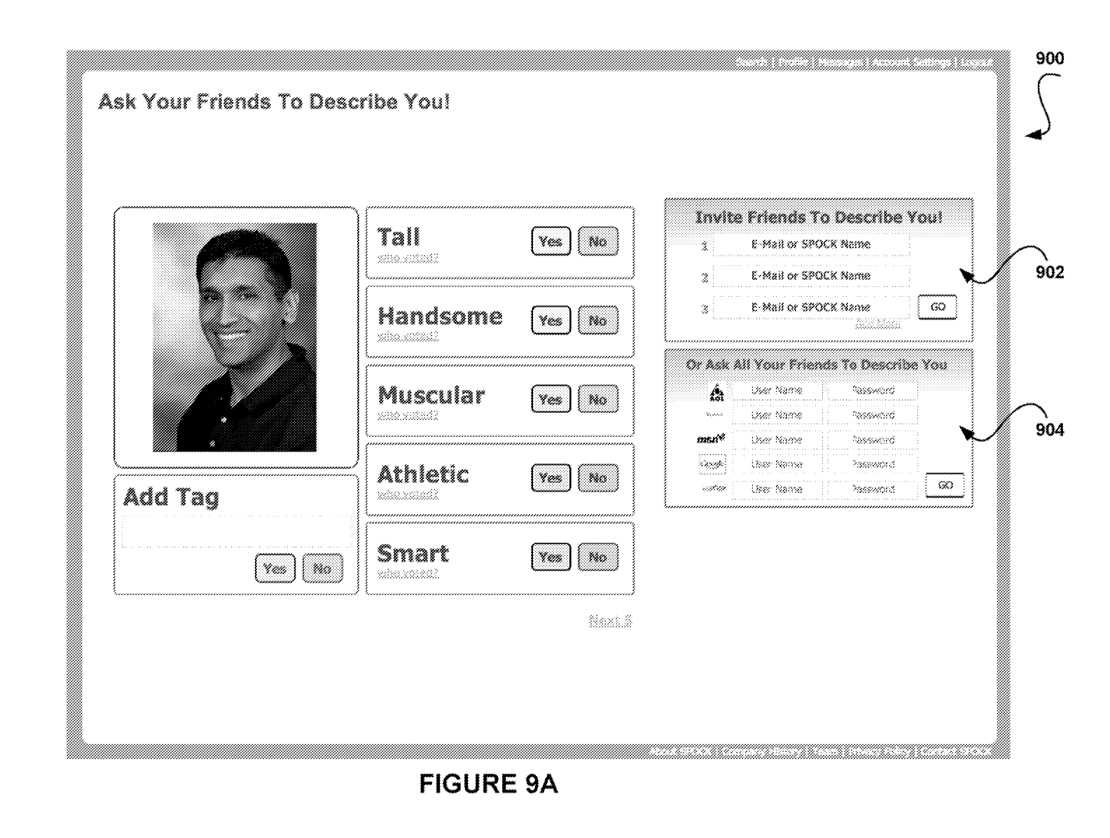

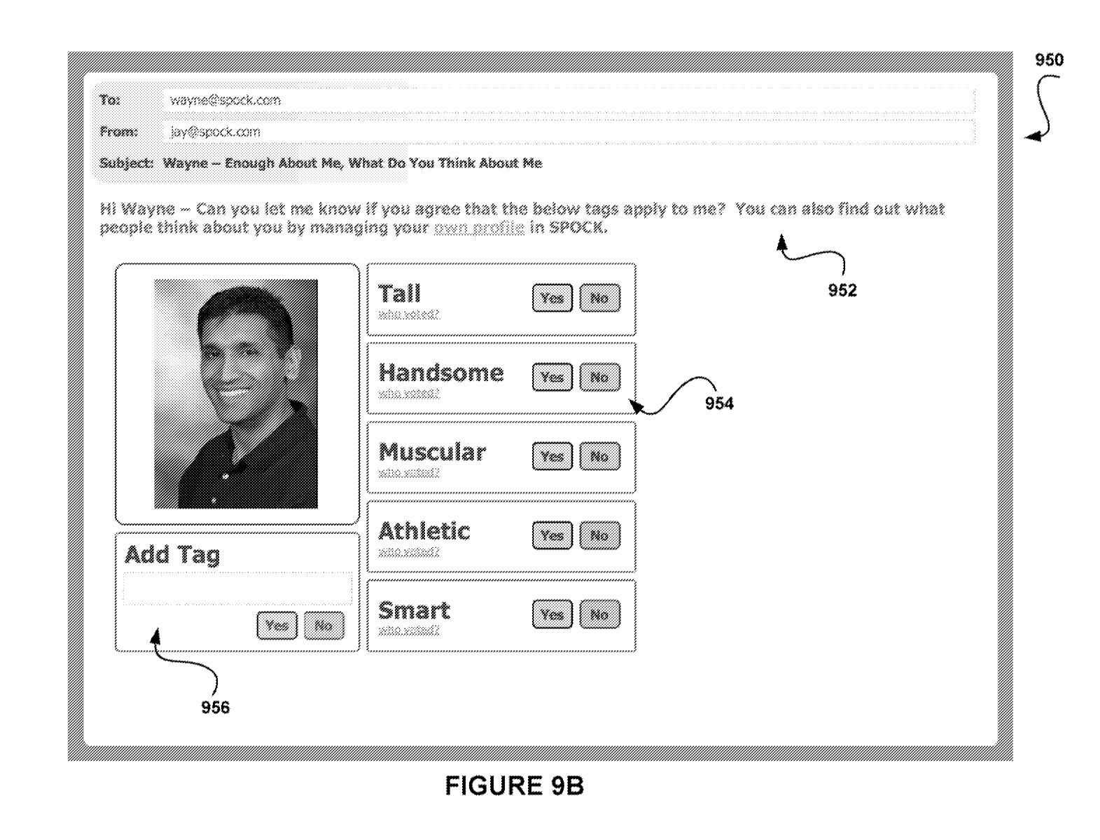

In addition, the tag may be created by associating the tag with the selected profile. Such associated may be performed utilizing a drag and drop technique (e.g. of predefined tags, etc.), utilizing user-configured entry (e.g. of customized tags, etc.), etc. Various examples of GUIs for accomplishing this will be described in further detail with respect to FIGS. 8, 9A, and 9B. Further, the tag may be posted to the application server by sending a tagging request to the application server. The request may include a request to insert the tag into the associated profile, for example. As an option, the application server may include the application server described above with respect to FIG. 4.

The application server than receives the tagging request and writes the tag to an information and tag storage, as shown in operation 504. The information and tag storage may therefore tags in association with the profiles. As an option, the tagging request may be confirmed prior to writing the tag to the information and tag storage. Just by way of example, a person making the tagging request may be verified. Such verification may be carried out by verifying that the person is the user associated with the profile in which the tagging request is being made, that the person has been solicited to make the tagging request by the user associated with the profile, that the person is, at the very least, logged in, etc.

Still yet, in operation 506, tags and votes stored in the information and tag storage are read and an analysis is performed to generate statistics, utilizing a tag analytic server (e.g. see the tag analytic server of FIG. 4). In one embodiment, the tags may be read in real-time upon the tag being written to the information and tag storage. In another embodiment, the tags may be read periodically. Of course, however, the tags may be read in an desired manner.

Moreover, the analysis may include ranking profiles associated with the tags. In particular, the ranking may be based on the generated statistics. Such statistics may include, for example, statistics for each tag regarding a ratio of positive feedback associated with the tags to negative feedback associated with the tags. Of course, however, the statistics may include any desired computation based on the tags.

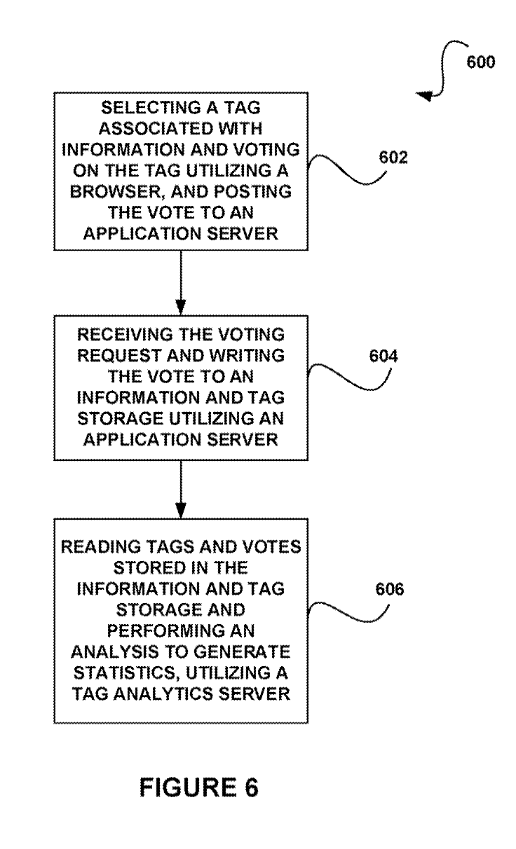

In addition, the analysis may include ranking the profiles based on feedback (e.g. votes, etc.) associated with the tags. One example of such feedback will be described in further detail with respect to FIG. 6. In this way, a profile may be returned in conjunction with a subset of ranked profiles upon receipt of a search query that matches the tag(s).

FIG. 6 illustrates a method 600 for voting with respect to a tag, in accordance with still yet another embodiment. As an option, the method 600 may be implemented in the context of the details of FIGS. 1-5. Of course, however, the method 600 may be carried out in any desired environment. Further, the aforementioned definitions may equally apply to the description below.

As shown in operation 602, a tag associated with information is selected and voted upon utilizing a browser, and the vote is posted to an application server. The tag may be voted on positively or negatively. For example, the tag may be voted on utilizing a true and false voting scheme.

An another example, the tag may be voted upon utilizing a range of agreement and/or disagreement with respect to a particular tag (e.g. based on a scale of 1-10, a percentage, etc.). Of course, the tag may be voted on in any desired manner. Furthermore, the vote may be posted to the application server by transmitting a voting request to an application server from a browser.

The voting request is received by the applications server and the application server writes the vote to an information and tag storage, as shown in operation 604. As an option, the application server may confirm the vote prior to writing the vote to the information and tag storage. For example, the application server may verify that the vote is made by a valid person (e.g. a user of the particular profile associated with the tag on which the vote was made, a person from whom the vote was solicited, a person with a separate profile from the profile associated with the tag on which the vote was made, etc.).

Tags and votes stored in the aformentioned and tag storage are then read and an analysis is performed to generate statistics, utilizing a tag analytics server, as shown in operation 606. In one embodiment, the tags and votes may be read in real-time upon the vote being written to the information and tag storage. In another embodiment, the tags and votes may be read periodically. Of course, however, the tags and votes may be read in any desired manner.

As described above with respect to FIG. 5, the analysis performed on the tags may include ranking profiles associated with the tags. Just by way of example, the votes stored in the information and tag storage may be read and a ratio of positive votes to negative votes for each tag may be identified. The ratio may then be utilized to rank the profiles. In this way, the tag and/or profile associated therewith may be returned in conjunction with a subset of ranked profiles upon receipt of a search query that matches the tag.

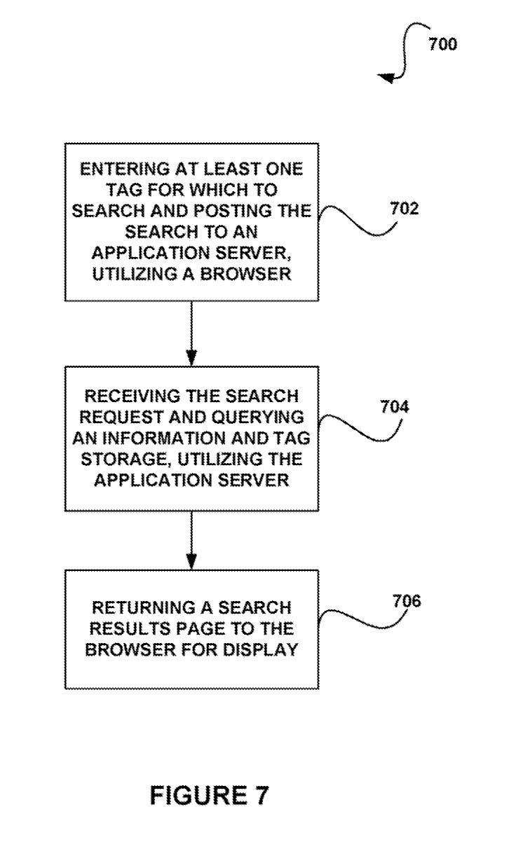

FIG. 7 illustrates a method 700 for performing a search based on a tag, in accordance with another embodiment. As an option, the method 700 may be implemented in the context of the details of FIGS. 1-6. Of course, however, the method 700 may be carried out in any desired environment. Further, the aforementioned definitions may equally apply to the description below.

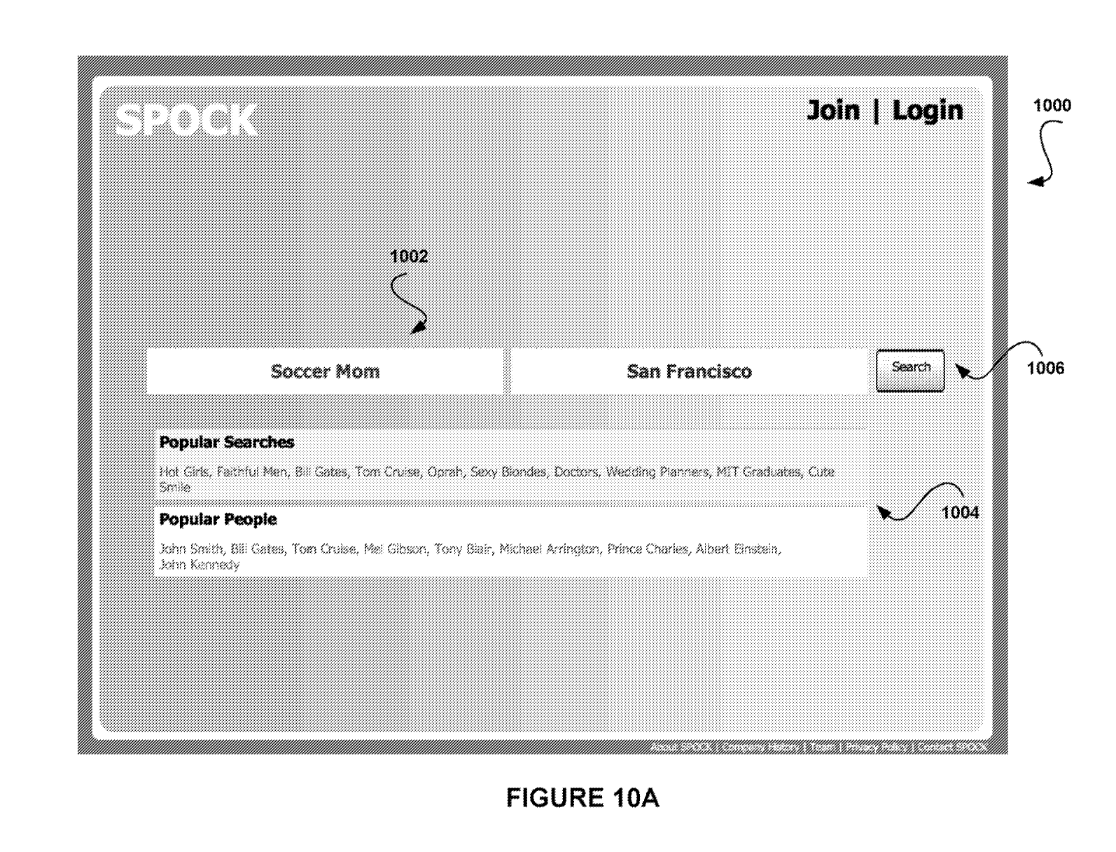

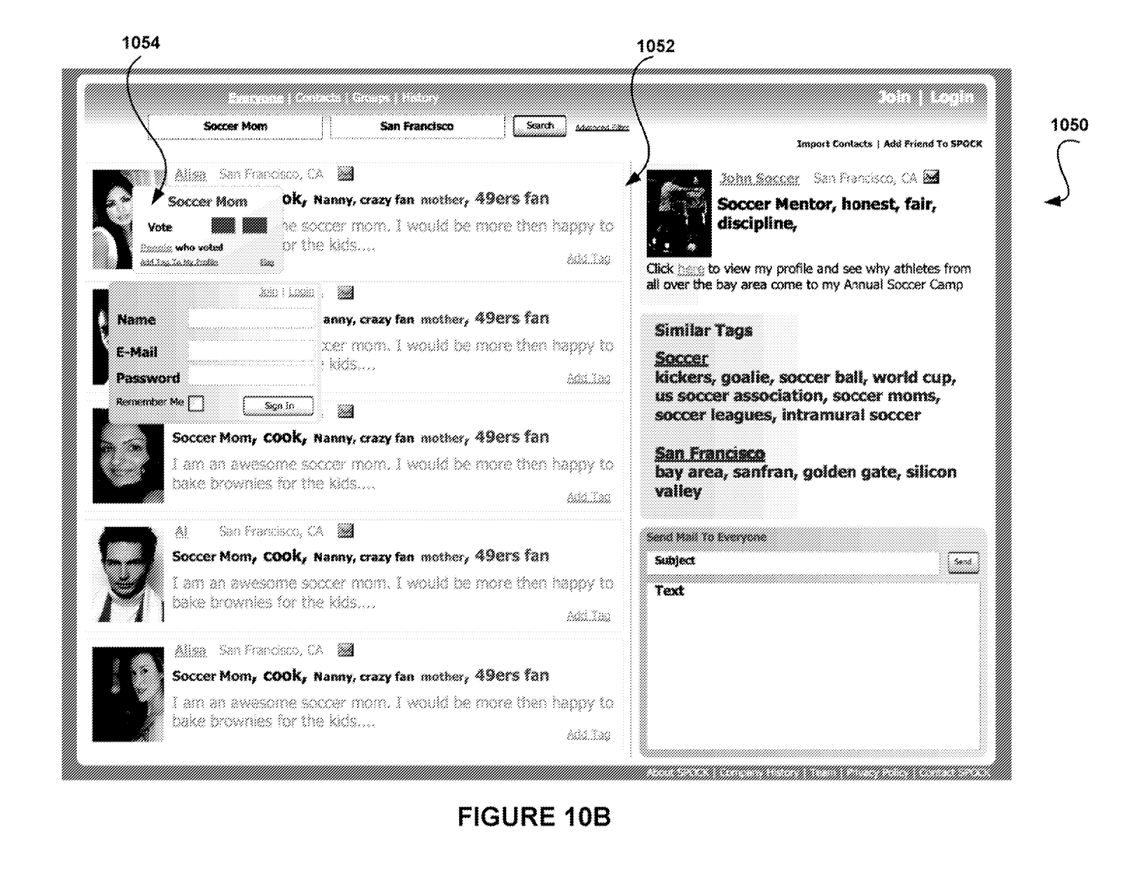

As shown in operation 702, at least one tag is entered (e.g. selected, manually entered, etc.), and a search is posted to an application server, utilizing a browser. In one embodiment, the tag may be entered into a GUI displayed on the browser. One example of such a GUI will be described in further detail with respect to FIG. 10A.

Moreover, the search may be posted to the application server by transmitting a search request to the application server. In addition, the search request is received by the application server and an information and tag storage is queried, utilizing the application server, as shown in operation 704. As an option, the search request may be confirmed prior to query the information and tag storage. Examples of such confirmation are confirmed above with respect to FIG. 5.

The information and tag storage may be queried by comparing the tag entered utilizing the browser to tags located in the information and tag storage. In this way, tags, and therefore profiles, within the information and tag storage that match the tags within the search request may be identified. Of course, as another option, tags within the information and tag storage that match at least one of the tags may also be identified.

As an option, the application server may rank the profiles associated with the identified tags. For example, the application server may rank the profiles according to feedback associated with the identified tags. Examples of such ranking may include those described above with respect to FIG. 6.

In one embodiment where a plurality of tags is entered into the search, the profiles associated with the tags may optionally be ranked according to a number of matched tags. Further, in such embodiment, the profiles may be ranked according to the ratio of positive votes to negative votes for each of the matched tags. In this way, profiles with the highest ranking may include profiles with the greatest number of matched tags and the greatest amount of positive votes for such matched tags.

Still yet, a search results GUI is returned to the browser for display, as shown in operation 706. The search results page may display a list of profiles that include the tag that was searched. In addition, the search results page may display the list of profiles according to rankings associated with the profiles. One example of such a GUI will be described in further detail with respect to FIG. 10B.

FIG. 8 illustrates a GUI 800 for voting with respect to a tag associated with a profile, in accordance with one embodiment. As an option, the GUI 800 may be implemented in the context of the details of FIGS. 1-7. Of course, however, the GUI 800 may be used in any desired environment. Further, the aforementioned definitions may equally apply to the description below.

As shown, the GUI 800 includes a description pane 802. The description pane 802 allows a user to describe a profile of an entity. In addition, the description pane 802 includes a menu 804 of additional sub-panes. The sub-panes may include a personal description pane 806 (as shown), a pictures pane for displaying pictures associated with the entity, a comments pane for display comments associated with the entity, a personal pane for displaying personal information, and/or any other pane capable of providing information associated with the entity.

The GUI 800 also includes a tag pane 808. The tag pane allows a user of the profile and/or any persons to enter tags that describe the entity associated with the profile. Thus, as shown, the tag pane 808 may include descriptive tags such as “tall,” “handsome,” “athletic,” etc.

In addition, tags within the tag pane 808 may be selected. Of course, such selection may occur in any desired manner (e.g. by hovering a cursor over the tag, clicking on the tag, etc.). As shown, a tag drop down box 810 may be displayed upon selection of a tag. The tag drop down box 810 may allow one to vote on the associated tag. Thus, one may vote on whether he or she believes the tag accurately describes the entity associated with the profile. For example, as shown, the tag drop down box may allow one to vote on whether he or she believes the entity associated with the profile (i.e. “Jay”) is “honest.”

Furthermore, the tag drop down box 810 may display a list of other people who have voted on the associated tag. Each of the names of people in the list may include hypertext links. Selection of such hypertext links may result in the display of information on how the particular person voted, a display of the person's profile, etc. Thus, the GUI 800 allows a profile to be displayed and further allows voting on tags that describe the profiled entity.

FIGS. 9A-B illustrate GUIs 900 and 950 for soliciting votes with respect to tags associated with a profile, in accordance with another embodiment. As an option, the GUIs 900 and 950 may be implemented in the context of the details of FIGS. 1-8. Of course, however, the GUIs 900 and 950 may be used in any desired environment. Again, the aforementioned definitions may equally apply to the description below.

As shown in FIG. 9A, a first GUI 900 may allow a user associated with a profile to solicit votes. The user may enter contact information of people he or she desires to solicit in a contact pane 902. Specifically, the contact pane 902 may allow the user to enter e-mail addresses, other profile names and/or any other type of contact information capable of being associated with a person. In this way, the user may ask other people to vote on tags associated with the user's profile. As an option, the first GUI 900 may also allow the user to solicit additional tags from such people.

The first GUI 900 may also allow the user to enter contact information associated with such user in a personal contact pane 904. The personal contact pane 904 may allow a user to enter user names and passwords of accounts which may, in turn, to be used to retrieve all contact information stored in association which such accounts. Such accounts may include, foe example, e-mail accounts, IM accounts, etc. Accordingly, all contacts managed by such accounts may be solicited.

With reference now to FIG. 9B, second GUI 950 may be provided to allow the user to preview the solicitation before ending. As shown, the solicitation may be provided in an e-mail. Of course, however, the solicitation may be provided utilizing any type of media.

Specifically, the solicitation may display a personal message 952 to the intended recipient. The solicitation may also include tags 954 currently associated with the profile of the user. The tags 954 may be capable of being voted upon by the recipient. As shown, the recipient may voter on the tags by selecting a “yes” option (e.g. indicating that the recipient agrees with the tag) or a “no” option (e.g. indicating that the recipient doe snot agree with the tag). Moreover, the recipient may be capable of adding tags that he or she wants associated with the user's profile in an additional tag pane 956.

FIGS. 10A-B illustrate GUIs 1000 and 1050 for searching profiles utilizing tags and for displaying search results based on a ranking associated with the tags, in accordance with yet another embodiment. As an option, the GUIs 1000 and 1050 may be implemented in the context of the details of FIGS. 1-9B. Of course, however, the GUIs 1000 and 1050 may be used in any desired environment. Yet again, the aforementioned definitions may equally apply to the description below.

As shown in FIG. 10A, a first GUI 1000 may allow anyone to search profiles. One may enter tags to be searched in at least one search box 1002. It should be noted that any number of search boxes may be utilized for further refining a search (e.g. by location, etc.). Moreover, each search box may hold a plurality of entered tags. In addition, the GUI 1000 may display popular tags 1004 that have been searched in the past.

Once one selects a search option 1006, a second GUI 1050 may be displayed. Note FIG. 10B. The second GUI 1050 may display profiles that match the tags searched. Specifically, a list of profiles may be displayed.

The list of profiles may include a predetermined number of profiles (e.g. 100 profiles, 1000 profiles, etc.). Further, the number of profiles displayed may be customized. In addition, the profiles may be displayed according to a rank of each profile. Just by way of example, a profile with a highest number of positive votes for a searched tag may be displayed first in the list of profiles. As another example, a profile with the highest ratio of positive votes to negative votes for a searched tag may be displayed first in the list of profiles. Of course, however, the profiles may be ranked in any desired manner.

Still yet, each displayed profile may include displayed tags associated with the profile. One may, in turn, select any of the tags and a voting pane 1054 may be displayed for permitting a vote on the particular tag. As an option, a registration/log-in may be included, if the person voting is currently unknown by the system. Moreover, the voting pane 1054 may display a number of instances of feedback (e.g. votes) already received for the selected tag (not shown). In this way, the number of instances of feedback may be displayed utilizing the GUI 1050 with which the list of profiles is displayed, or any other interface for that matter.

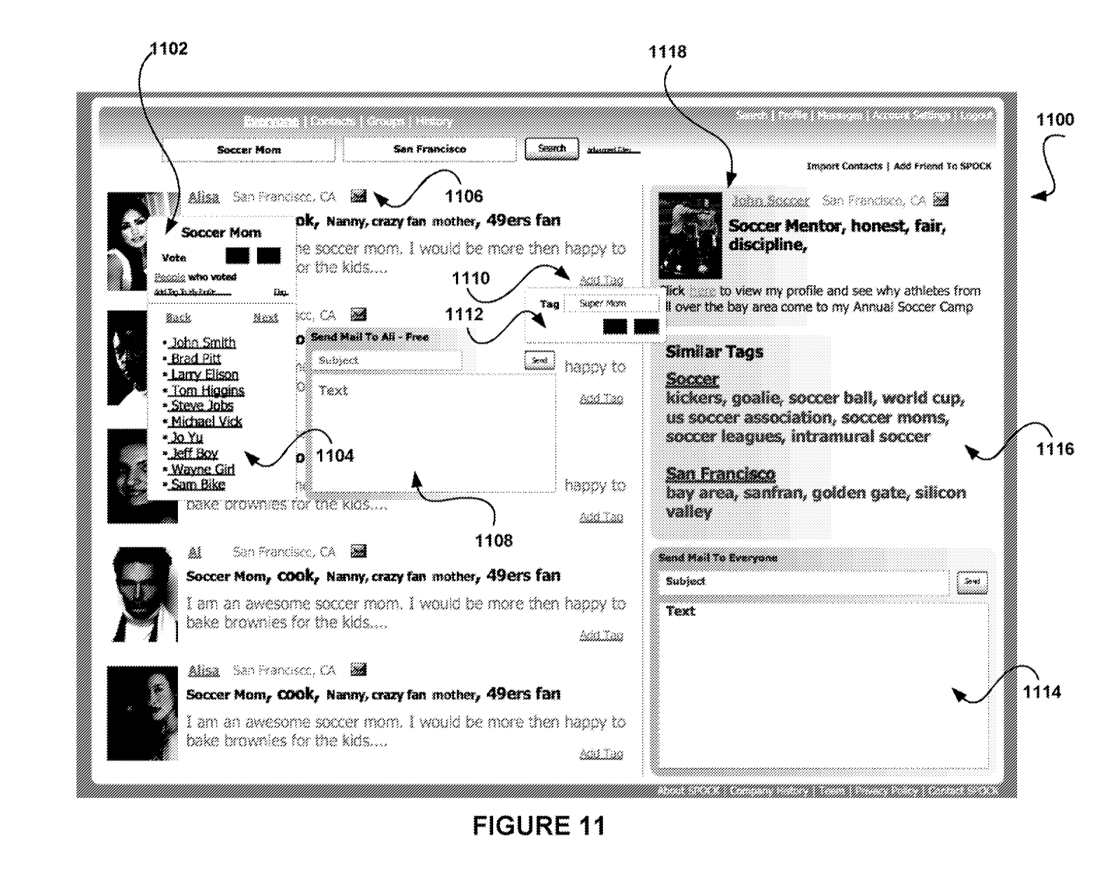

FIG. 11 illustrates a GUI 1100 for voting with respect to a tag associated with a profile within displayed search results, in accordance with still yet another embodiment. As an option, the GUI 1100 may be implemented in the context of the details of FIGS. 1-10B. Of course, however, the GUI 1100 may be implemented in any desired environment. Again, the aforementioned definitions may equally apply to the description below.

As shown, the GUI 1100 may display a list of profiles matching a search tag or a plurality of search tags. As also shown, a voting pane 1102 may be displayed upon selection of a displayed tag associated with a displayed profile. The voting pane 1102 may allow one to choose to view a list of names 1104 of people who have already voted on the selected tag. Thus, as shown, the names may be displayed utilizing the GUI 1100 in which the profiles matching the searched tags are displayed, or any other interface for that matter.

As a further option, the GUI 1100 may also provide a mail icon 1106 associated with each profile. Upon selection of the mail icon 1106, a message box 1108 may be displayed for transmitting a message to the entity associated with the profile. Still yet, the GUI 1100 may provide an additional tag option 1110, upon selection of which an additional tag box 1112 is displayed for entering another tag to be associated with the instant profile.

As also shown, a mass message box 1114 may be provided for sending a message to all entities associated with the displayed profiles. Furthermore, a similar tags box 1116 may be displayed for providing synonyms and/or related terms that could be utilized for receiving similar profiles. As yet a further option, a featured profile 1118 may be displayed.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
receiving feedback relating to tags associated with a plurality of profiles;
receiving a search query;
identifying a subset of the profiles based on the search query;
ranking the subset of the profiles based on the feedback; and
displaying the subset of the profiles based on the ranking.

2. The method of claim 1, wherein at least one of the tags is generated manually.

3. The method of claim 1, wherein at least one of the tags is generated automatically.

4. The method of claim 2, wherein at least one of the tags is generated utilizing a drag and drop operation.

5. The method of claim 1, wherein the profiles describe an entity selected from the group consisting of a person, a place and a thing.

6. The method of claim 1, wherein the subset of the profiles is identified by comparing the search query with the tags associated with the plurality of profiles.

7. The method of claim 6, wherein the subset of the profiles includes only profiles with an associated tag that matches the search query.

8. The method of claim 1, wherein the subset of the profiles is displayed in a list in an order based on the ranking.

9. The method of claim 1, wherein the feedback includes votes relating to the tags.

10. The method of claim 9, wherein the profiles are ranked, at least in part, as a function of the votes received in relation to an associated tag that matches the search query.

11. The method of claim 9, wherein the profiles are ranked, at least in part, as a function of a strength of match between the search query, and the tags and data associated with the profiles.

12. The method of claim 1, wherein the feedback is weighted.

13. The method of claim 1, wherein a number of instances of the feedback is displayed.

14. The method of claim 13, wherein the number of instances of feedback is displayed utilizing an interface with which the subset of the profiles is displayed.

15. The method of claim 13, wherein the number of instances of feedback is displayed with first interface separate from a second interface with which the subset of the profiles is displayed.

16. The method of claim 1, and further comprising displaying names of people from whom the feedback is received.

17. The method of claim 16, wherein the names are displayed utilizing an interface with which the subset of the profiles is displayed.

18. The method of claim 16, wherein the names are displayed with a first interface separate from a second interface with which the subset of the profiles is displayed.

19. A computer program product embodied on a computer readable medium, comprising:
computer code for identifying a subset of profiles based on a search query; and
computer code for ranking the subset of the profiles based on feedback relating to tags associated with the profiles.

20. A system, comprising:
a processor, the processor serving to identify a subset of profiles based on a search query, and rank the subset of the profiles based on feedback relating to tags associated with the profiles.
